(19) United States
(12) Patent Application Publication
(10) Pub. No.: US 2024/0373220 A1
(43) Pub. Date: Nov. 7, 2024

(54) METHOD AND APPARATUS FOR AUTHENTICATING USER EQUIPMENT IN WIRELESS COMMUNICATION SYSTEM

(71) Applicant: Samsung Electronics Co., Ltd., Gyeonggi-do (KR)

(72) Inventor: Kisuk KWEON, Gyeonggi-do (KR)

(21) Appl. No.: 18/682,278

(22) PCT Filed: Aug. 9, 2022
(86) PCT No.: PCT/KR2022/011820

§ 371 Date: Feb. 8, 2024

(30) Foreign Application Priority Data
Aug. 9, 2021 (KR) 10-2021-0104925

(51) Int. Cl. H04W 12/06; H04L 9/40; H04W 12/72; H04W 60/00; H04W 84/10

(52) U.S. Cl. CPC H04W 12/06; H04L 63/0892; H04W 12/72; H04W 60/00; H04W 84/10

(57) ABSTRACT

The present disclosure relates to a 5G, pre-5G or 6G communication system for supporting a higher data transmission rate than a 4G communication system such as LTE. Provided is a method performed by an AUSF entity in a wireless communication system, the method comprising the steps of: receiving, via an access and AMF entity, an authentication request message for registration of user equipment to a stand-alone non-public network; receiving, from a UDM entity, a message including information indicating that initial authentication for the registration of the user equipment to the SNPN needs to be performed by an authentication server outside the SNPN; selecting an authentication server to perform the initial authentication of the user equipment; transmitting the authentication request message for the user equipment to the selected authentication server; receiving an authentication response message from the selected authentication server; and transmitting the authentication response message to the user equipment.

### TECHNICAL FIELD

The disclosure relates to a method and a device for authentication and authorization when registering a terminal with a standalone non-public network (SNPN) in a wireless communication system.

### BACKGROUND ART

To meet the demand for wireless data traffic having increased since deployment of 4th generation (4G) communication systems, efforts have been made to develop an improved 5th generation (5G) or pre-5G communication system. Therefore, the 5G or pre-5G communication system is also called a “beyond 4G network” communication system or a “post long term evolution (post LTE)” system.

The 5G communication system is considered to be implemented in ultrahigh frequency (mmWave) bands (e.g., 60 GHz bands) so as to accomplish higher data rates. To decrease propagation loss of the radio waves and increase the transmission distance in the ultrahigh frequency bands, beamforming, massive multiple-input multiple-output (massive MIMO), full dimensional MIMO (FD-MIMO), array antenna, analog beam forming, large scale antenna techniques are discussed in 5G communication systems.

In addition, in 5G communication systems, development for system network improvement is under way based on advanced small cells, cloud radio access networks (cloud RANs), ultra-dense networks, device-to-device (D2D) communication, wireless backhaul, moving network, cooperative communication, coordinated multi-points (CoMP), reception-end interference cancellation and the like.

In the 5G system, hybrid FSK and QAM modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have also been developed.

The 5G system is considering supports for more various services as compared to the conventional 4G system. For example, the most representative service may include a ultrawide band mobile communication service (enhanced mobile broad band (eMBB)), an ultrahigh reliable/low latency communication service (ultra-reliable and low latency communication (URLLC)), a massive device-to-device communication service (massive machine type communication (mMTC)), and a next-generation broadcast service (evolved multimedia broadcast/multicast service (eMBMS)). A system providing the URLLC service may be referred to as a URLLC system, and a system providing the eMBB service may be referred to as an eMBB system. The terms “service” and “system” may be interchangeably used.

Among these services, the URLLC service that is a new service under consideration in the 5G system in contrast to the existing 4G system requires to meet ultrahigh reliability (e.g., packet error rate of about 10-5) and low latency (e.g., about 0.5 msec) conditions as compared to the other services. To meet these strict conditions required therefor, the URLLC service may need to apply a shorter transmission time interval (TTI) than the eMBB service, and various operating scheme employing the same are now under consideration.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have been recently researched.

Such an IoT environment may provide intelligent Internet technology (IT) services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies such as a sensor network, machine type communication (MTC), and machine-to-machine (M2M) communication may be implemented by beamforming, MIMO, and array antennas. Application of a cloud radio access network (cloud RAN) as the above-described big data processing technology may also be considered an example of convergence of the 5G technology with the IoT technology.

### DETAILED DESCRIPTION OF THE INVENTION

### Technical Problem

As various services can be provided in accordance with the development of mobile communication systems, there is a need particularly for a method to efficiently use a non-public network (NPN). Disclosed embodiments are to provide a device and a method capable of efficiently providing an NPN service in a wireless communication system.

### Technical Solution

As various services can be provided in accordance with the development of mobile communication systems, there is particularly a need for a method to efficiently use a non-public network (NPN). Disclosed embodiments are to provide a device and a method capable of efficiently providing an NPN service in a wireless communication system.

An aspect of various embodiments of the disclosure is to provide a method and a device for, when a terminal is registered with an SNPN, authenticating the terminal by communicating with an authentication server located outside the SNPN.

In various embodiments of the disclosure, proposed is a method performed by an authentication server function (AUSF) entity in a wireless communication system, the method including: receiving an authentication request message of a terminal for a standalone non-public network (SNPN) registration via an access and mobility management function (AMF) entity; receiving, from a unified data management (UDM) entity, a message including information indicating that primary authentication of the terminal for the SNPN registration needs to be performed by an authentication server external to the SNPN; selecting an authentication server in which the primary authentication of the terminal is to be performed; transmitting an authentication request message for the terminal to the selected authentication server; receiving an authentication response message from the selected authentication server; and transmitting the authentication response message to the terminal.

In various embodiments of the disclosure, provided is a method performed by a terminal in a wireless communication system, the method including: transmitting a first authentication request message to an authentication server function (AUSF) entity; and receiving, from the AUSF entity, a first authentication response message that is a response message to the authentication request message, wherein the first authentication response message is received from the AUSF entity when the AUSF entity receives a second authentication response message for the terminal from an authentication server in which primary authentication of the terminal is to be performed, and the second authentication response message is received in response to a second authentication request message for the terminal, which is transmitted to the authentication server in which the primary authentication of the terminal is to be performed, the authentication server being selected based on that the AUSF entity receives, via an access and mobility management function (AMF) entity, an authentication request message of the terminal for a standalone non-public network (SNPN) registration, and receives, from a unified data management (UDM) entity, a message comprising information indicating that the primary authentication of the terminal for the SNPN registration needs to be performed by an authentication server external to the SNPN.

In various embodiments of the disclosure, provided is a method performed by an authentication server in a wireless communication system, the method including: receiving an authentication request message of a terminal for a standalone non-public network (SNPN) registration from an authentication server function (AUSF) entity; performing terminal authentication; and transmitting an authentication response message for the terminal to the AUSF entity, wherein the authentication request message is transmitted to the authentication server selected based on that the AUSF receives, from a unified data management (UDM) entity, a message including information indicating that primary authentication of the terminal for the SNPN registration needs to be performed by an authentication server external to the SNPN.

In various embodiments of the disclosure, provided is an authentication server function (AUSF) entity in a wireless communication system, the AUSF entity including a transceiver, and at least one processor, wherein the at least one processor is configured to: receive an authentication request message of a terminal for a standalone non-public network (SNPN) registration via an access and mobility management function (AMF) entity; receive, from a unified data management (UDM) entity, a message including information indicating that primary authentication of the terminal for the SNPN registration needs to be performed by an authentication server external to the SNPN; select an authentication server in which the primary authentication of the terminal is to be performed; transmit an authentication request message for the terminal to the selected authentication server; receive an authentication response message from the selected authentication server; and transmit the authentication response message to the terminal.

In various embodiments of the disclosure, provided is a terminal in a wireless communication system, the terminal including a transceiver, and at least one processor, wherein the at least one processor is configured to: transmit a first authentication request message to an authentication server function (AUSF) entity; and receive, from the AUSF entity, a first authentication response message that is a response message to the authentication request message, and wherein the first authentication response message is received from the AUSF entity when the AUSF entity receives a second authentication response message for the terminal from an authentication server in which primary authentication of the terminal is to be performed, and the second authentication response message is received in response to a second authentication request message for the terminal, which is transmitted to the authentication server in which the primary authentication of the terminal is to be performed, the authentication server being selected based on that the AUSF entity receives, via an access and mobility management function (AMF) entity, an authentication request message of the terminal for a standalone non-public network (SNPN) registration, and receives, from a unified data management (UDM) entity, a message comprising information indicating that the primary authentication of the terminal for the SNPN registration needs to be performed by an authentication server external to the SNPN.

In various embodiments of the disclosure, provided is an authentication server in a wireless communication system, the authentication server including a transceiver, and at least one processor, wherein the at least one processor is configured to: receive an authentication request message of a terminal for a standalone non-public network (SNPN) registration from an authentication server function (AUSF) entity; perform terminal authentication in response to the authentication request message; and transmit an authentication response message for the terminal to the AUSF entity, and wherein the authentication request message is transmitted to the authentication server selected based on that the AUSF receives, from a unified data management (UDM) entity, a message including information indicating that the primary authentication of the terminal for the SNPN registration needs to be performed by an authentication server external to the SNPN.

The technical subjects pursued in the disclosure may not be limited to the above-mentioned technical subjects, and other technical subjects which are not mentioned may be clearly understood, through the following descriptions, by those skilled in the art to which the disclosure pertains.

### Advantageous Effects

According to various embodiments of the disclosure, a device and a method enabling a terminal to effectively receive an NPN service in a wireless communication system can be provided.

According to various embodiments of the disclosure, a method enabling, for registration with an SNPN, a terminal to be authenticated from an authentication server external to the SNPN, thereby reducing overhead and delay can be provided.

According to various embodiments of the disclosure, communication can be performed with an AAA server of an external CH via an AUSF of 5GC, and an authentication procedure for SNPN registration of a terminal can be performed.

### BRIEF DESCRIPTION OF DRAWINGS

FIG. 1 illustrates a structure of a 5G network according to an embodiment of the disclosure;

FIG. 2 illustrates a 5th generation system (5GS) structure for using an authentication, authorization, and accounting (AAA) server-based credentials holder (CH) according to an embodiment of the disclosure:

FIG. 3A and FIG. 3B are flowcharts illustrating a procedure for registration of a terminal with an SNPN according to various embodiments of the disclosure:

FIG. 4 is a diagram illustrating elements of a network entity according to an embodiment of the disclosure;

FIG. 5 is a diagram illustrating elements of a terminal according to an embodiment of the disclosure; and

FIG. 6 is a diagram illustrating elements of an authentication server (AAA server) according to an embodiment of the disclosure.

### MODE FOR CARRYING OUT THE INVENTION

Hereinafter, exemplary embodiments of the disclosure will be described in detail with reference to the accompanying drawings. It should be noted that, in the drawings, the same or like elements are designated by the same or like reference signs as much as possible. Furthermore, a detailed description of known functions or configurations that may make the subject matter of the disclosure unclear will be omitted.

In describing embodiments of the disclosure, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card.

In the following description, a base station is an entity that allocates resources to terminals, and may be at least one of a Node B, a base station (BS), an eNode B (eNB), a gNode B (gNB), a wireless access unit, a base station controller, and a node on a network. A terminal may include a user equipment (UE), a mobile station (MS), a cellular phone, a smartphone, a computer, or a multimedia system capable of performing communication functions. In addition, the embodiments of the disclosure may be applied to other communication systems having similar technical backgrounds or channel types. Furthermore, based on determinations by those skilled in the art, the embodiments of the disclosure may be applied to other communication systems through some modifications without significantly departing from the scope of the disclosure.

In the following description, terms for identifying access nodes, terms referring to network entities or network functions (NFs), terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

In the following description of the disclosure, some of terms and names defined in the 3rd generation partnership project long term evolution (3GPP LTE) standards will be used for the sake of descriptive convenience. However, the disclosure is not limited by these terms and names, and may be applied in the same way to systems that conform other standards.

In embodiments of the disclosure, when a terminal is registered with an SNPN, the terminal is authenticated by communicating with a credentials holder (CH) based on an AAA server located outside the SNPN. To this end, an SNPN network structure and interface definition for communication of SNPN and CH are proposed.

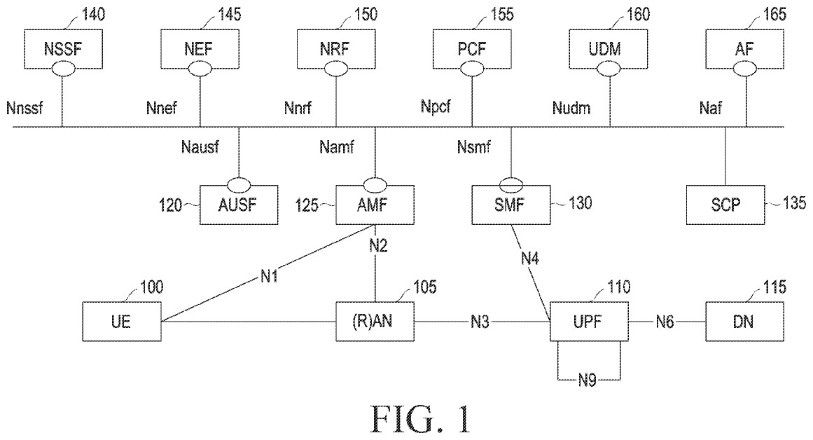

FIG. 1 illustrates a structure of a 5G network according to an embodiment of the disclosure. Descriptions of network entities or network nodes constituting the 5G network are as follows.

A (radio) access network ((R)AN) 105 is a subject that performs radio resource allocation for a terminal, and may be at least one of an eNode B, a Node B, a base station (BS), a next generation radio access network (NG-RAN), a 5G-AN, a radio access unit, a base station controller, or a node on a network.

A terminal 100 may include a user equipment (UE), a next generation UE (NG UE), a mobile station (MS), a cellular phone, a smartphone, a computer, or a multimedia system capable of performing a communication function. In addition, hereinafter, an embodiment of the disclosure will be described using a 5G system as an example, but embodiments of the disclosure may also be applied to other communication systems having a similar technical background. In addition, the embodiments of the disclosure may be applied to other communication systems via some modifications without significantly departing from the scope of the disclosure at the discretion of a person with skilled technical knowledge.

While evolving from a 4G system to a 5G system, a wireless communication system defines a new core network that is a NextGen (NG) core or 5G core network (5GC). In a new core network, all legacy network entities (NEs) are virtualized to become network functions (NFs). According to an embodiment of the disclosure, a network function may refer to a network entity, a network component, or a network resource.

According to an embodiment of the disclosure, 5GC may include at least one of NFs illustrated in FIG. 1. The disclosure is certainly not limited to the illustration of FIGS. 1, and 5GC may include more or fewer NFs than the NFs illustrated in FIG. 1. The 5GC or core network may be configured to include the NFs in one device or multiple devices.

According to an embodiment of the disclosure, an access and mobility management function (AMF) 125 may be an access and mobility management function entity and may be a network function that manages mobility of the terminal.

According to an embodiment of the disclosure, a session management function (SMF) 130 may be a session management function entity and may be a network function that manages a packet data network (PDN) connection provided to the terminal. A PDN connection may be referred to as a packet data unit (PDU) session.

According to an embodiment of the disclosure, a policy control function (PCF) 155 may be a policy control function entity and may be a network function that applies a PDU session policy, a charging policy, and a service policy of a mobile communication operator to the terminal.

According to an embodiment of the disclosure, a unified data management (UDM) 160 may be an integrated data management entity and may be a network function that stores information on a subscriber.

According to an embodiment of the disclosure, a network exposure function (NEF) 145 may be a function that provides information on the terminal to a server external to the 5G network. In addition, the NEF may provide a function of providing information necessary for a service to the 5G network and storing the same in a UDR.

According to an embodiment of the disclosure, a user plane function (UPF) 110 may be a function that serves as a gateway for transferring user data (PDU) to a data network (DN).

According to an embodiment of the disclosure, a network repository function (NRF) 150 may perform a function of discovering an NF.

According to an embodiment of the disclosure, an authentication server function (AUSF) 120 may be an authentication server function entity and may perform terminal authentication in a 3GPP access network and a non-3GPP access network.

According to an embodiment of the disclosure, a network slice selection function (NSSF) 140 may perform a function of selecting a network slice instance provided to the terminal.

According to an embodiment of the disclosure, a data network (DN) 115 may be a data network via which the terminal transmits or receives data to use a network operator's service or a third-party service.

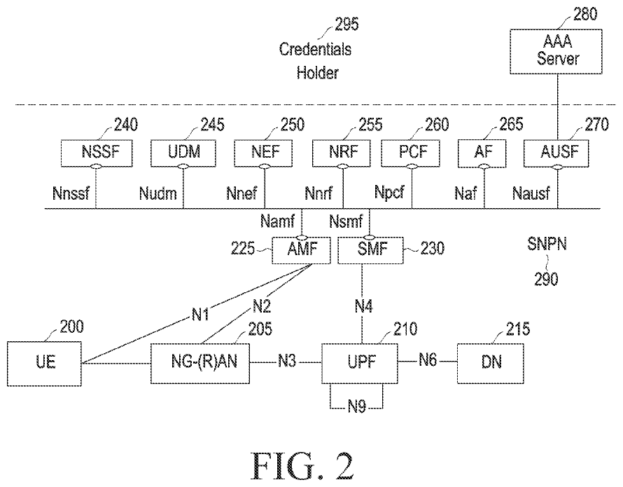

FIG. 2 illustrates a 5th generation system (5GS) structure for using an authentication, authorization, and accounting (AAA) server-based credentials holder (CH) according to an embodiment of the disclosure.

A credentials holder (CH) 295 is a network or entity that authenticates a terminal (UE) 200 in order for the terminal to access an SNPN 290 and may exist outside the SNPN 290. When the terminal 200 accesses the SNPN 290 to register with the SNPN 290, a UDM 245 may determine that the terminal needs to be primarily authenticated by an AAA server 280 in the CH 295 via a subscriber permanent identifier (subscription permanent identifier (SUPI)) and subscriber information (UE subscription data) of the terminal. The AAA server may be named as an authentication server or an external authentication server. When it is determined that authentication is required by the AAA server 280, the UDM 245 may command an AUSF 270 to perform terminal authentication with the AAA server 280 in the CH 295. In order to perform terminal authentication, a control plane (CP) interface for transmission of terminal authentication information and signaling related thereto may be required between the AUSF 270 and the AAA server 280.

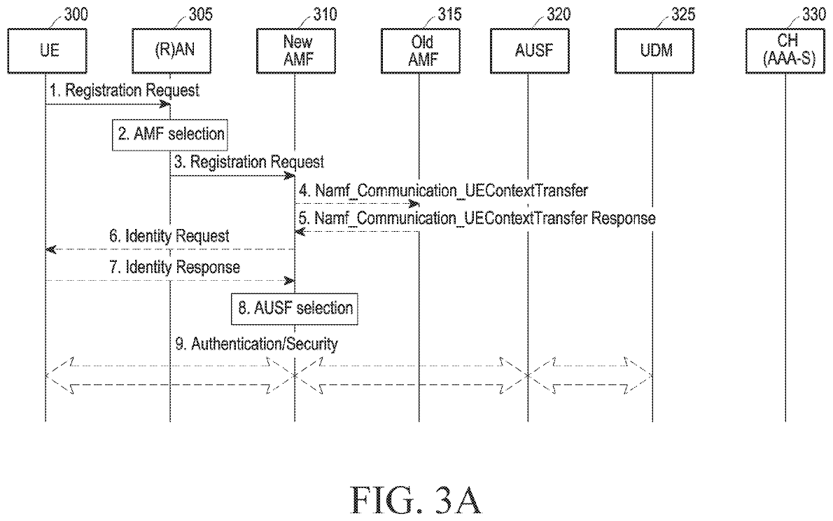

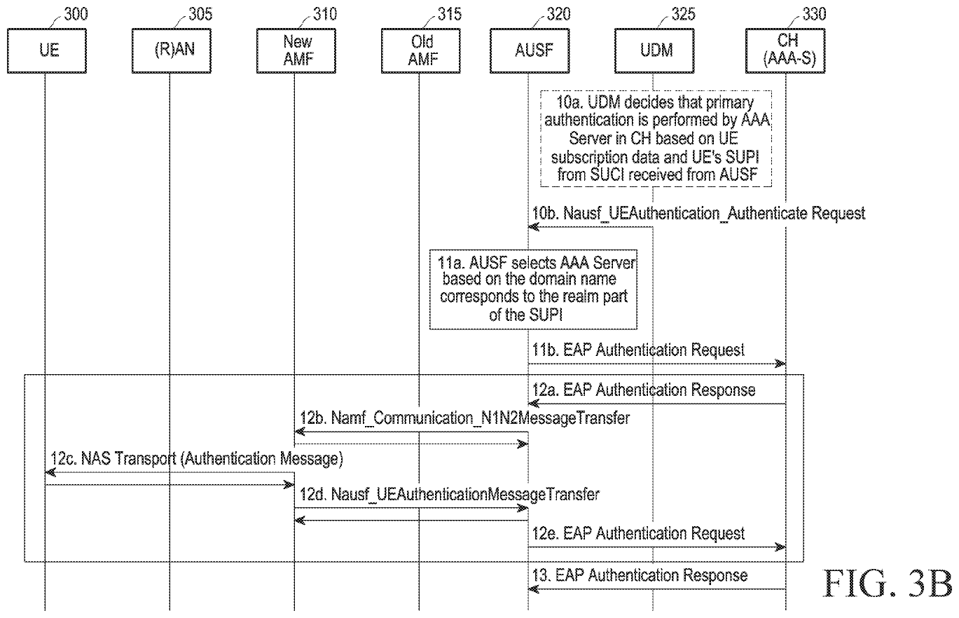

FIG. 3A and FIG. 3B are flowcharts illustrating a procedure for registration of a terminal with an SNPN according to various embodiments of the disclosure.

In operations 1-7, a terminal (UE) 300 transmits a registration request message to a (R)AN 305 to register with an SNPN. The (R)AN 305 selects a new AMF 310 (hereinafter, AMF 310), based on requested network slice selection assistance information (NSSAI) information and (radio) access technology ((R)AT) information transmitted by the terminal 300, so as to transmit the registration request message to the selected AMF 310. If the terminal has previously registered with the SNPN, and thus there is an old AMF 315 having served to the terminal, the newly selected AMF 310 may request UE context information from the old AMF 315 and receive the UE context information in response thereto. Optionally, the AMF 310 may transmit an identity request to the terminal 300. The terminal 300 may transmit an identity response to the AMF 310 in response to the identity request.

The AMF may perform terminal authentication. In operation 8, in order to perform terminal authentication, the AMF 310 may select an AUSF 320, based on information on a subscription concealed identifier (SUCI) or an SUPI of the terminal.

If the AMF 310 determines, in operation 9, that terminal authentication is necessary, the AMF 310 requests terminal authentication from the AUSF 320 selected in operation 8. The AUSF 320 selects a UDM 325 to obtain terminal authentication information from the UDM 325 and requests the terminal authentication information from the UDM 325.

In operation 10a, the UDM 325 may determine that terminal authentication is required by an AAA server 330 in a CH, based on at least one of the SUPI received from the AUSF 320 and subscriber information (UE subscription data) of the terminal. The SUPI and the subscriber information of the terminal may include information indicating that the terminal needs to be authenticated by the AAA server of the CH external to the SNPN.

In operation 10b, the UDM 325 may transmit an Nasuf_UEAuthentication_Authenticate request message to the AUSF 320. The Nasuf_UEAuthentication_Authenticate request message may include information indicating to the AUSF 320 that authentication of the terminal 30) needs to be performed by the AAA server 330 existing in the CH outside the SNPN.

In operation 11a, the AUSF 320 selects an AAA server that is to authenticate the terminal 300. A non-3GPP SUPI, which does not include an international mobile subscriber identity (IMSI), has a network access identifier (NAI) structure. A realm part of this SUPI has a domain name of the CH 330. That is, the AUSF 320 may select and address the AAA server, based on a realm part of the SUPI of the terminal 300.

In operation 11b, for terminal authentication, the AUSF 320 transmits, to the AAA server 330, an extensible authentication protocol (EAP) authentication request message for triggering of the terminal authentication. This message may include an EAP message.

In operations 12a-12c, the AAA server 330 transmits an EAP authentication response message to the AUSF 320 in order to authenticate the terminal 300. This message may include an EAP message. This message is transferred to the terminal 300 via the AMF 310. In operation 12b, the AUSF 320 may transmit an Nausf_Communication message to the AMF 310. In operation 12c, the AMF 310 may transmit the Nausf_Communication message to the terminal 300. Information included in the messages of operations 12a-12c may be information for terminal authentication.

In operations 12c-12e, the terminal 300 transfers the EAP message to the AAA server 330 via the AMF 310 and the AUSF 320. In operation 12d, the AMF 310 may transmit an Nausf_UEAuthenticationMessageTransfer message to the AUSF 320. In operation 12e, the AUSF 320 may transmit an EAP authentication request message to the AAA server 330. Information included in the messages of operations 12c-12e may include information requested by the AAA server 330 for registration of the terminal 300 with the SNPN.

In operation 13, if terminal authentication is successful, the AAA server 330 provides a notification of the success to the AUSF via an EAP authentication response message. The SNPN performs a terminal registration procedure subsequent to the terminal authentication. The AAA server 330 may perform the terminal authentication based on the information received from the terminal 300 via the messages of operations 12c-12e.

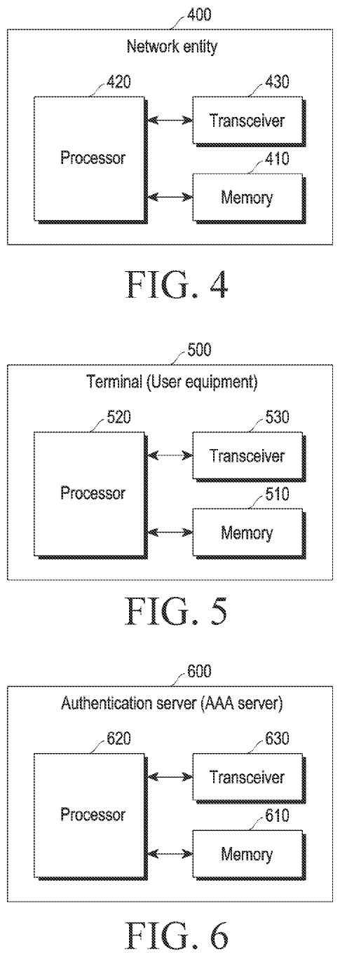

FIG. 4 is a diagram illustrating elements of a network entity according to an embodiment of the disclosure.

A network entity 400 according to the embodiments disclosed in FIG. 1 to FIG. 3 of the disclosure may include a processor 420 configured to control overall operations of the network entity 400, a transceiver 430 including a transmitter and a receiver, and memory 410. The disclosure is certainly not limited to the illustration, and the network entity may include more or fewer elements than the elements illustrated in FIG. 4. The network entity 400 may be a concept including the (R)AN, core network, or 5GC disclosed in FIG. 1. (For example, the network entity may include at least one of (R)AN, AMF, SMF, AUSF, UDM, AF, UPF, DN, SCP, PCF, NRF, NEF, and NSSF.)

According to an embodiment of the disclosure, the transceiver 430 may transmit a signal to or receive a signal from at least one of a terminal or another network entity. A signal transmitted to or received from at least one of a terminal or another network entity may include control information and data.

According to an embodiment of the disclosure, the processor 420 may control the network entity 400 to perform one of the embodiments described above. The processor 420, the memory 410, and the transceiver 430 do not necessarily have to be implemented as separate modules, and may certainly be implemented as a single element unit in the form of a single chip. The processor 420 and the transceiver 430 may be electrically connected. In addition, the processor 420 may be an application processor (AP), a communication processor (CP), a circuit, an application-specific circuit, or at least one processor.

According to an embodiment of the disclosure, the memory 410 may store data, such as basic programs, application programs, and configuration information for operation of the network entity. In particular, the memory 410 provides stored data in response to a request of the processor 420. The memory 410 may include storage media, such as a ROM, a RAM, a hard disk, a CD-ROM, and a DVD, or a combination of storage media. In addition, there may be multiple memories 410. In addition, the processor 420 may perform the aforementioned embodiments, based on programs for performing the aforementioned embodiments of the disclosure, which are stored in the memory 410.

FIG. 5 is a diagram illustrating elements of a terminal according to an embodiment of the disclosure.

A terminal 500 according to the embodiments disclosed in FIG. 1 to FIG. 3 of the disclosure may include a processor 520 configured to control overall operations of the terminal 500, a transceiver 530 including a transmitter and a receiver, and memory 510. The disclosure is certainly not limited to the illustration, and the terminal may include more or fewer elements than the elements illustrated in FIG. 5.

According to an embodiment of the disclosure, the transceiver 530 may transmit a signal to or receive a signal from a network entity or another terminal. A signal transmitted to or received from a network entity may include control information and data. In addition, the transceiver 530 may receive a signal through a wireless channel, output the signal to the processor 520, and transmit, through the wireless channel, the signal output from the processor 520.

According to an embodiment of the disclosure, the processor 520 may control the terminal to perform one of the embodiments described above. The processor 520, the memory 510, and the transceiver 530 do not necessarily have to be implemented as separate modules, and may certainly be implemented as a single element unit in the form of a single chip. The processor 520 and the transceiver 530 may be electrically connected. In addition, the processor 520 may be an application processor (AP), a communication processor (CP), a circuit, an application-specific circuit, or at least one processor.

According to an embodiment of the disclosure, the memory 510 may store data, such as basic programs, application programs, and configuration information for operation of the terminal. In particular, the memory 510 provides stored data in response to a request of the processor 520. The memory 510 may include storage media, such as a ROM, a RAM, a hard disk, a CD-ROM, and a DVD, or a combination of storage media. In addition, there may be multiple memories 510. In addition, the processor 520 may perform the aforementioned embodiments, based on programs for performing the aforementioned embodiments of the disclosure, which are stored in the memory 510.

FIG. 6 is a diagram illustrating elements of an authentication server (AAA server) according to an embodiment of the disclosure.

An authentication server 600 according to the embodiments disclosed in FIG. 1 to FIG. 3 of the disclosure may include a processor 620 configured to control overall operations of the authentication server (AAA server) included in a CH, a transceiver 630 including a transmitter and a receiver, and memory 610. The disclosure is certainly not limited to the illustration, and the authentication server may include more or fewer elements than the elements illustrated in FIG. 6.

According to an embodiment of the disclosure, the transceiver 630 may transmit a signal to or receive a signal from at least one of a terminal or another network entity. A signal transmitted to or received from at least one of a terminal or another network entity may include control information and data.

According to an embodiment of the disclosure, the processor 620 may control the authentication server 60 to perform one of the embodiments described above. The processor 620, the memory 610, and the transceiver 630 do not necessarily have to be implemented as separate modules, and may certainly be implemented as a single element unit in the form of a single chip. The processor 620 and the transceiver 630 may be electrically connected. In addition, the processor 620 may be an application processor (AP), a communication processor (CP), a circuit, an application-specific circuit, or at least one processor.

According to an embodiment of the disclosure, the memory 610 may store data, such as basic programs, application programs, and configuration information for operation of the authentication server 600. In particular, the memory 610 provides stored data in response to a request of the processor 620. The memory 610 may include storage media, such as a ROM, a RAM, a hard disk, a CD-ROM, and a DVD, or a combination of storage media. In addition, there may be multiple memories 610. In addition, the processor 620 may perform the aforementioned embodiments, based on programs for performing the aforementioned embodiments of the disclosure, which are stored in the memory 610.

It should be noted that the above-described configuration diagrams, illustrative diagrams of control/data signal transmission methods, illustrative diagrams of operation procedures, and structural diagrams are not intended to limit the scope of the disclosure. That is, all constituent elements, entities, or operation steps described in the embodiments of the disclosure should not be construed as being essential for the implementation of the disclosure, and the disclosure may be implemented without impairing the essential features of the disclosure by including only some constituent elements. In addition, the respective embodiments may be employed in combination, as necessary. For example, the methods proposed in the disclosure may be partially combined with each other to operate a network entity and a terminal.

The above-described operations of a base station or terminal may be implemented by providing any unit of the base station or terminal device with a memory device storing corresponding program codes. That is, a controller of the base station or terminal device may perform the above-described operations by reading and executing the program codes stored in the memory device by means of a processor or central processing unit (CPU).

Various units or modules of a network entity, a base station device, or a terminal device may be operated using hardware circuits such as complementary metal oxide semiconductor-based logic circuits, firmware, or hardware circuits such as combinations of software and/or hardware and firmware and/or software embedded in a machine-readable medium. For example, various electrical structures and methods may be implemented using transistors, logic gates, and electrical circuits such as application-specific integrated circuits.

When implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments, but should be defined by the appended claims and equivalents thereof. That is, it will be apparent to those skilled in the art that other variants based on the technical idea of the disclosure may be implemented. Furthermore, the above respective embodiments may be employed in combination, as necessary. For example, the methods proposed in the disclosure may be partially combined with each other to operate abase station and a terminal. Furthermore, although the above embodiments have been described by way of 5G and NR systems, other variants based on the technical idea of the embodiments may also be implemented in other systems such as LTE, LTE-A, and LTE-A-Pro systems.

Although specific embodiments have been described in the detailed description of the disclosure, it will be apparent that various modifications and changes may be made thereto without departing from the scope of the disclosure. Therefore, the scope of the disclosure should not be defined as being limited to the embodiments, but should be defined by the appended claims and equivalents thereof.

1. A method performed by an authentication server function (AUSF) entity in a wireless communication system, the method comprising:
receiving an authentication request message of a terminal for a standalone non-public network (SNPN) registration via an access and mobility management function (AMF) entity;
receiving, from a unified data management (UDM) entity, a message comprising information indicating that primary authentication of the terminal for the SNPN registration needs to be performed by an authentication server external to the SNPN;
selecting an authentication server in which the primary authentication of the terminal is to be performed;
transmitting the authentication request message for the terminal to the selected authentication server;
receiving an authentication response message from the selected authentication server; and
transmitting the authentication response message to the terminal.

2. The method of claim 1, wherein the information indicating that the primary authentication of the terminal for the SNPN registration needs to be performed by the authentication server external to the SNPN is included in the message in case that the UDM entity determines that the primary authentication of the terminal for the SNPN registration needs to be performed by the authentication server external to the SNPN, based on at least one of subscriber information of the terminal and a subscription permanent identifier (SUPI) of the terminal.

3. The method of claim 1, wherein the selecting of the authentication server comprises selecting the authentication server, based on a subscription permanent identifier (SUPI) of the terminal.

4. A method performed by a terminal in a wireless communication system, the method comprising:
transmitting a first authentication request message to an authentication server function (AUSF) entity; and
receiving, from the AUSF entity, a first authentication response message that is a response message to the first authentication request message,
wherein the first authentication response message is received from the AUSF entity in case that the AUSF entity receives a second authentication response message for the terminal from an authentication server in which primary authentication of the terminal is to be performed, and
wherein the second authentication response message is received in response to a second authentication request message for the terminal, which is transmitted to the authentication server in which the primary authentication of the terminal is to be performed, the authentication server being selected based on that the AUSF entity receives, via an access and mobility management function (AMF) entity, the first authentication request message of the terminal for a standalone non-public network (SNPN) registration, and receives, from a unified data management (UDM) entity, a message comprising information indicating that the primary authentication of the terminal for the SNPN registration needs to be performed by an authentication server external to the SNPN.

5. The method of claim 4, wherein the information indicating that the primary authentication of the terminal for the SNPN registration needs to be performed by the authentication server external to the SNPN is included in the message in case that the UDM entity determines that the primary authentication of the terminal for the SNPN registration needs to be performed by the authentication server external to the SNPN, based on at least one of subscriber information of the terminal and a subscription permanent identifier (SUPI) of the terminal.

6. The method of claim 4, wherein the authentication server is selected based on a subscription permanent identifier (SUPI) of the terminal.

7-8. (canceled)

9. An authentication server function (AUSF) entity in a wireless communication system, the AUSF entity comprising:
a transceiver; and
at least one processor,
wherein the at least one processor is configured to:
receive an authentication request message of a terminal for a standalone non-public network (SNPN) registration via an access and mobility management function (AMF) entity;
receive, from a unified data management (UDM) entity, a message comprising information indicating that primary authentication of the terminal for the SNPN registration needs to be performed by an authentication server external to the SNPN;
select an authentication server in which the primary authentication of the terminal is to be performed;
transmit the authentication request message for the terminal to the selected authentication server;
receive an authentication response message from the selected authentication server; and
transmit the authentication response message to the terminal.

10. The AUSF entity of claim 9, wherein the information indicating that the primary authentication of the terminal for the SNPN registration needs to be performed by the authentication server external to the SNPN is included in the message in case that the UDM entity determines that the primary authentication of the terminal for the SNPN registration needs to be performed by the authentication server external to the SNPN, based on at least one of subscriber information of the terminal and a subscription permanent identifier (SUPI) of the terminal.

11. The AUSF entity of claim 9, wherein the at least one processor is configured to select the authentication server, based on a subscription permanent identifier (SUPI) of the terminal.

12. A terminal in a wireless communication system, the terminal comprising:
a transceiver; and
at least one processor,
wherein the at least one processor is configured to:
transmit a first authentication request message to an authentication server function (AUSF) entity; and
receive, from the AUSF entity, a first authentication response message that is a response message to the first authentication request message, and
wherein the first authentication response message is received from the AUSF entity in case that the AUSF entity receives a second authentication response message for the terminal from an authentication server in which primary authentication of the terminal is to be performed, and
wherein the second authentication response message is received in response to a second authentication request message for the terminal, which is transmitted to the authentication server in which the primary authentication of the terminal is to be performed, the authentication server being selected based on that the AUSF entity receives, via an access and mobility management function (AMF) entity, the first authentication request message of the terminal for a standalone non-public network (SNPN) registration, and receives, from a unified data management (UDM) entity, a message comprising information indicating that the primary authentication of the terminal for the SNPN registration needs to be performed by an authentication server external to the SNPN.

13. The terminal of claim 12, wherein the information indicating that the primary authentication of the terminal for the SNPN registration needs to be performed by the authentication server external to the SNPN is included in the message in case that the UDM entity determines that the primary authentication of the terminal for the SNPN registration needs to be performed by the authentication server external to the SNPN, based on at least one of subscriber information of the terminal and a subscription permanent identifier (SUPI) of the terminal.

14-15. (canceled)
